(19) United States
(12) Patent Application Publication
(10) Pub. No.: US 2023/0242797 A1
(43) Pub. Date: Aug. 3, 2023

(54) PRESSURE-SENSITIVE ADHESIVE COMPOSITION, PRESSURE-SENSITIVE ADHESIVE, PRESSURE-SENSITIVE ADHESIVE SHEET, AND LAMINATE

(71) Applicant: LINTEC CORPORATION, Tokyo (JP)

(72) Inventors: Minami NAKANISHI, Tokyo (JP); Yutaka NANASHIMA, Tokyo (JP)

(73) Assignee: LINTEC CORPORATION, Tokyo (JP)

(21) Appl. No.: 17/923,290

(22) PCT Filed: Mar. 19, 2021
(86) PCT No.: PCT/JP2021/011500

§ 371 Date: Nov. 4, 2022

(30) Foreign Application Priority Data
May 7, 2020 (JP) 2020-082053

(51) Int. Cl. C09J 133/14; C09J 7/38

(52) U.S. Cl. CPC C09J 133/14; C09J 7/385

(57) ABSTRACT

A pressure sensitive adhesive composition that includes: a (meth)acrylic ester polymer (A) containing, as a monomer unit constituting the polymer, an ethylene carbonate-containing monomer having an ethylene carbonate structure represented by Formula (1) below; and an ionic compound (B).

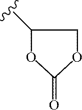

### TECHNICAL FIELD

The present invention relates to a pressure sensitive adhesive composition, a pressure sensitive adhesive, a pressure sensitive adhesive sheet, and a laminate that are suitable for the use for a display body (display) and the like.

### BACKGROUND ART

Various mobile electronic devices such as smartphones and tablet terminals in recent years are equipped with displays using display body modules having liquid crystal elements, light emitting diodes (LED elements), organic electroluminescence (organic EL) elements, etc., and such displays may often serve as touch panels.

In such a display as above, a protective panel is usually provided on the surface side of the display body module. Along with the reduction in thickness/weight of electronic devices, the above protective panel has been changed from the conventional glass plate to a plastic plate such as an acrylic plate or a polycarbonate plate.

Here, an air gap is provided between the protective panel and the display body module so that even when the protective panel is deformed due to external force, the deformed protective panel does not collide with the display body module.

When an air gap as above or an air layer exists, however, the reflection loss of light due to a refractive index difference between the protective panel and the air layer and a refractive index difference between the air layer and the display body module is large, and there is a problem in that the image quality of display deteriorates.

To overcome this problem, it has been proposed to improve the image quality of display by filling the air gap between the protective panel and the display body module with a pressure sensitive adhesive layer. For example, Patent Document 1 discloses, as the pressure sensitive adhesive layer filling the air gap between the protective panel and the display body module, a pressure sensitive adhesive layer having a shear storage elastic modulus (G′) at 25° C. and 1 Hz of 1.0×10⁵ Pa or less and a gel fraction of 40% or more.

### PRIOR ART DOCUMENTS

### Patent Documents

[Patent Document 1] JP2010-97070A

### SUMMARY OF THE INVENTION

### Problems to Be Solved by the Invention

In Patent Document 1, it is attempted to improve step followability by lowering the storage elastic modulus at ordinary temperatures of the pressure sensitive adhesive layer. If the storage elastic modulus at ordinary temperatures is lowered as above, however, the storage elastic modulus at high temperatures will be lowered more than necessary, and a problem may occur under durable conditions. For example, when subjected to high-temperature and high-humidity conditions, air bubbles or the like may be generated in the vicinity of a step. Moreover, in the conventional pressure sensitive adhesive layer, optical unevenness may occur such as that the vicinity of a step appears distorted in appearance.

The present invention has been made in consideration of such actual circumstances, and an object of the present invention is to provide a pressure sensitive adhesive composition, a pressure sensitive adhesive, a pressure sensitive adhesive sheet, and a laminate that are excellent in the step followability and can suppress the occurrence of optical unevenness.

### Means for Solving the Problems

To achieve the above object, first, the present invention provides a pressure sensitive adhesive composition comprising: a (meth)acrylic ester polymer (A) containing, as a monomer unit constituting the polymer, an ethylene carbonate-containing monomer having an ethylene carbonate structure represented by Formula (1) below; and an ionic compound (B) (Invention 1).

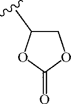

In the above invention (Invention 1), by containing the above components, the obtained pressure sensitive adhesive exhibits good cohesive strength without containing a crosslinker and is excellent in the handling ability (e.g., workability or the like when using a pressure sensitive adhesive sheet). Moreover, excellent stress relaxation properties are exhibited together with the cohesive strength, thus resulting in excellent step followability from the initial stage to under high-temperature and high-humidity conditions. Furthermore, the above excellent stress relaxation properties suppress the occurrence of optical unevenness (such as optical distortion). Then, when obtaining a pressure sensitive adhesive, an aging period is unnecessary because the above pressure sensitive adhesive composition does not need to contain a crosslinker, and the productivity of pressure sensitive adhesive sheets can be improved.

In the above invention (Invention 1), the (meth)acrylic ester polymer (A) may preferably contain 0.5 mass% or more and 40 mass% or less of the ethylene carbonate-containing monomer as the monomer unit constituting the polymer (Invention 2).

In the above invention (Invention 1, 2), the ionic compound (B) may be preferably an alkali metal salt (Invention 3).

In the above invention (Invention 1 to 3), the content of the ionic compound (B) in the pressure sensitive adhesive composition may be preferably 0.1 mass parts or more and 2 mass parts or less with respect to 100 mass parts of the (meth)acrylic ester polymer (A) (Invention 4).

In the above invention (Invention 1 to 4), the content of a crosslinker in the pressure sensitive adhesive composition may be preferably 0.1 mass parts or less with respect to 100 mass parts of the (meth)acrylic ester polymer (A) (Invention 5).

Second, the present invention provides a pressure sensitive adhesive obtained by crosslinking the pressure sensitive adhesive composition (Invention 1 to 5) (Invention 6).

Third, the present invention provides a pressure sensitive adhesive sheet comprising at least a pressure sensitive adhesive layer, wherein the pressure sensitive adhesive layer is composed of the pressure sensitive adhesive (Invention 6) (Invention 7).

Fourth, the present invention provides a pressure sensitive adhesive sheet comprising at least a pressure sensitive adhesive layer, wherein the strain amount of a pressure sensitive adhesive constituting the pressure sensitive adhesive layer is 50% or more and 260% or less at 25° C. after 1210 seconds from when applying a stress of 7950 Pa to the pressure sensitive adhesive, wherein, provided that the maximum relaxation elastic modulus value of the pressure sensitive adhesive constituting the pressure sensitive adhesive layer measured when straining the pressure sensitive adhesive by 10% in accordance with JIS K7244-1 is a maximum relaxation elastic modulus G(t)ₘₐₓ (MPa) and the minimum relaxation elastic modulus value measured while continuing to strain the pressure sensitive adhesive by 10% until 3757 seconds after the maximum relaxation elastic modulus G(t)ₘₐₓ is measured is a minimum relaxation elastic modulus G(t)ₘᵢₙ (MPa), a relaxation elastic modulus fluctuation value Δlog(G(t)) calculated from Formula (X) below is 1.2 or more and 2.0 or less (Invention 8).

$$Δ \text{log} \left(\text{G} \left(\text{t}\right)\right) = log \left(\text{G} {\left(\text{t}\right)}_{\text{max}}\right) - log \left(\text{G} {\left(\text{t}\right)}_{min}\right)$$

In the above invention (Invention 7, 8), the pressure sensitive adhesive constituting the pressure sensitive adhesive layer may preferably have a gel fraction of 0% or more and 60% or less (Invention 9).

In the above invention (Invention 7 to 9), the pressure sensitive adhesive constituting the pressure sensitive adhesive layer may preferably have a storage elastic modulus (G′) at 50° C. of 0.01 MPa or more and 1 MPa or less (Invention 10).

In the above invention (Invention 7 to 10), the pressure sensitive adhesive constituting the pressure sensitive adhesive layer may preferably have a storage elastic modulus (G′) at 25° C. of 0.01 MPa or more and 1 MPa or less (Invention 11).

In the above invention (Invention 7 to 11), the pressure sensitive adhesive layer may preferably have an adhesive strength to soda-lime glass of 1 N/25 mm or more and 100 N/25 mm or less (Invention 12).

In the above invention (Invention 7 to 12), the pressure sensitive adhesive sheet may preferably comprise two release sheets, and the pressure sensitive adhesive layer may be preferably interposed between the two release sheets so as to be in contact with release surfaces of the two release sheets (Invention 13).

Fifth, the present invention provides a laminate comprising: a display body structural member; another display body structural member; and a pressure sensitive adhesive layer that bonds the display body structural member and the other display body structural member to each other, wherein the pressure sensitive adhesive layer is formed of the pressure sensitive adhesive layer of the pressure sensitive adhesive sheet (Invention 7 to 13) (Invention 14).

In the above invention (Invention 14), at least one of the display body structural member and the other display body structural member may preferably have a step on a surface on a side bonded by the pressure sensitive adhesive layer (Invention 15).

### Advantageous Effect of the Invention

The pressure sensitive adhesive composition, pressure sensitive adhesive, pressure sensitive adhesive sheet, and laminate according to the present invention are excellent in the step followability and can suppress the occurrence of optical unevenness.

### BRIEF DESCRIPTION OF DRAWINGS

FIG. 1 is a cross-sectional view of a pressure sensitive adhesive sheet according to an embodiment of the present invention.

FIG. 2 is a cross-sectional view of a laminate according to an embodiment of the present invention.

### EMBODIMENTS FOR CARRYING OUT THE INVENTION

Hereinafter, one or more embodiments of the present invention will be described.

### Pressure Sensitive Adhesive Composition

The pressure sensitive adhesive composition (which may be referred to as a “pressure sensitive adhesive composition P,” hereinafter) preferably contains a (meth)acrylic ester polymer (A) and an ionic compound (B). The (meth)acrylic ester polymer (A) contains, as a monomer unit constituting the polymer, an ethylene carbonate-containing monomer having an ethylene carbonate structure represented by Formula (1) below.

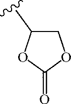

As used in the present specification, the term “(meth)acrylic acid” refers to both the acrylic acid and the methacrylic acid. The same applies to other similar terms. As used in the present specification, the term “polymer” encompasses the concept of a “copolymer.”

The (meth)acrylic ester polymer (A) is composed of the above ethylene carbonate-containing monomer, and the pressure sensitive adhesive composition P according to the present embodiment thereby includes the ethylene carbonate structure as a side chain of the (meth)acrylic ester polymer (A). When the ethylene carbonate structure is included as a side chain of the (meth)acrylic ester polymer (A), the interaction between side chains is strengthened, and the glass-transition temperature (Tg) of the (meth)acrylic ester polymer (A) is relatively high. This allows the obtained pressure sensitive adhesive to have a strong cohesive strength. Moreover, the ethylene carbonate structure includes two carbonyl dipoles. This allows the ethylene carbonate structure as a side chain of the (meth)acrylic ester polymer (A) and the ionic compound (B) to be bonded by interaction to form a pseudo-crosslinked structure. By including such a crosslinked structure, the obtained pressure sensitive adhesive exhibits good cohesive strength without containing a crosslinker and is excellent in the handling ability (e.g., workability or the like when using a pressure sensitive adhesive sheet). Furthermore, from the viewpoint of polarity of the ethylene carbonate structure, the obtained pressure sensitive adhesive has high adhesive strength, especially to glass. On the other hand, when a certain pressure (and heat) is applied to the pressure sensitive adhesive, the above crosslinked structure is loosened and excellent stress relaxation properties are exhibited; for example, when an adherend of the pressure sensitive adhesive has a step or the like, the pressure sensitive adhesive can easily follow the shape of the step or the like. After that, even when the certain pressure (and heat) is removed, the pseudo-crosslinked structure is formed again while maintaining the state of well following the shape of the step or the like. In such a case, the stress is less likely to remain in the pressure sensitive adhesive when it follows the shape of the step or the like; therefore, it is possible to suppress the force that the pressure sensitive adhesive attempts to return to the state before it follows the shape of the step or the like, and the state of well following the shape of the step or the like can be maintained. These actions and effects allow the pressure sensitive adhesive sheet obtained using the pressure sensitive adhesive to have excellent step followability from the initial stage to under high-temperature and high-humidity conditions. As referred to herein, the “initial stage” excludes immediately after attaching. The residual stress of general pressure sensitive adhesives appears remarkably in the vicinity of a step or the like; for example, even when the step followability is excellent from the initial stage to under high-temperature and high-humidity conditions (i.e., even when air bubbles, floating, or delamination may not occur in the vicinity of a step or the like), optical unevenness (such as optical distortion) may occur in the vicinity of the step or the like due to distortion of the pressure sensitive adhesive caused by the force that the pressure sensitive adhesive attempts to return to the state before it follows the shape of the step or the like. Fortunately, however, the pressure sensitive adhesive sheet obtained using the pressure sensitive adhesive obtained from the pressure sensitive adhesive composition P according to the present embodiment can suppress the force that the pressure sensitive adhesive attempts to return to the state before it follows the shape of the step or the like, and therefore is excellent in suppressing the optical unevenness in the vicinity of the step or the like, thus improving the image quality/appearance, for example, of a display. Furthermore, when obtaining the pressure sensitive adhesive, an aging period is unnecessary because the pressure sensitive adhesive composition according to the present embodiment does not need to contain a crosslinker, and the productivity of pressure sensitive adhesive sheets can thereby be improved. The “crosslinking” in the present specification includes not only general crosslinking due to covalent bonding but also pseudo-crosslinking due to interaction (including, but not limited to, those due to coordinate bonding, ionic bonding, intermolecular force, etc.).

### (1) Components of Pressure Sensitive Adhesive Composition

### 1) (Meth)Acrylic Ester Polymer (A)

The ethylene carbonate-containing monomer including the ethylene carbonate structure represented by the above Formula (1) is not particularly limited, provided that it includes the ethylene carbonate structure and can perform a polymerization reaction with other monomers that constitute the (meth)acrylic ester polymer (A).

Preferred examples of the ethylene carbonate-containing monomer include (meth)acrylic esters having a structure in which an organic group having an ethylene carbonate structure and a (meth)acryloyloxy group are bonded. Examples of such (meth)acrylic esters include an acrylic ester represented by the following Formula (2)

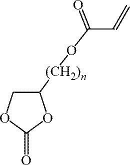

and a methacrylic ester represented by the following Formula (3).

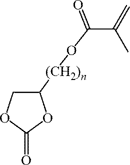

In both Formulae (2) and (3), n represents an integer of 0 or more. Among the (meth)acrylic esters represented by the above Formulae (2) and (3), a (meth)acrylic ester in which n is 1 or more may be preferred, and a (meth)acrylic ester in which n is 2 or more may also be preferred. When n is 1 or more, the ethylene carbonate group as a side chain of the (meth)acrylic ester polymer (A) is present at a position relatively distant from the main chain, and the probability that the ethylene carbonate structures present in the obtained pressure sensitive adhesive overlap each other increases. With this configuration, the stacking interaction between the ethylene carbonate structures works, and the mechanical properties (strain amount, relaxation elastic modulus fluctuation value, storage elastic modulus) and adhesive strength to be described later may be easily and suitably developed. Moreover, the interaction between the ethylene carbonate structure and the ionic compound (B) is easily developed, and a pseudo-crosslinked structure is more likely to be formed, thus enhancing the cohesive force. These actions allow the obtained pressure sensitive adhesive to be more excellent in the step followability. Furthermore, it is excellent in suppressing the optical unevenness and also excellent in the handling ability. The upper limit of the above n is not particularly limited, but from the viewpoint of polymerizability, it may be preferably 10 or less, more preferably 6 or less, particularly preferably 4 or less, and further preferably 3 or less. Among these, (meth)acrylic esters with n=2 may be preferred, and (2-oxo-1,3-dioxolan-4-yl)methyl methacrylate with n=2 in Formula (3) may be particularly preferred, from the viewpoints that the mechanical properties (strain amount, relaxation elastic modulus fluctuation value, storage elastic modulus) and adhesive strength of the obtained pressure sensitive adhesive may be easily improved and the step followability is more excellent. One type of the ethylene carbonate-containing monomer may be used alone or two or more types may also be used in combination.

The (meth)acrylic ester polymer (A) may preferably contain 0.5 mass% or more, more preferably 1 mass% or more, particularly preferably 5 mass% or more, and further preferably 10 mass% or more of the above ethylene carbonate-containing monomer as a monomer unit that constitutes the polymer. This allows the stacking interaction to work between the ethylene carbonate structures, and the mechanical properties (strain amount, relaxation elastic modulus fluctuation value, storage elastic modulus) and adhesive strength to be described later may be easily and suitably developed. In addition, the interaction between the ethylene carbonate structure and the ionic compound (B) is easily developed, and a pseudo-crosslinked structure is more likely to be formed, thus enhancing the cohesive force. These actions allow the obtained pressure sensitive adhesive to be more excellent in the step followability. Moreover, it is excellent in suppressing the optical unevenness and also excellent in the handling ability. Furthermore, from the viewpoint of polarity, the adhesive strength of the pressure sensitive adhesive, especially to glass, becomes high.

On the other hand, the (meth)acrylic ester polymer (A) may preferably contain 40 mass% or less, more preferably 30 mass% or less, particularly preferably 25 mass% or less, and further preferably 20 mass% or less of the above ethylene carbonate-containing monomer as a monomer unit that constitutes the polymer. This allows the mechanical properties (strain amount, relaxation elastic modulus fluctuation value, storage elastic modulus), which will be described later, to be easily satisfied, and the step followability will be more excellent.

The (meth)acrylic ester polymer (A) in the present embodiment may preferably contain (meth)acrylic alkyl ester as a monomer unit that constitutes the polymer. This allows the obtained pressure sensitive adhesive to develop good pressure sensitive adhesive properties. The alkyl group may be linear or branched.

From the viewpoint of pressure sensitive adhesive properties, (meth)acrylic alkyl ester whose carbon number of alkyl group is 1 to 20 may be preferred as the (meth)acrylic alkyl ester. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate.

Among the above, (meth)acrylic alkyl ester whose carbon number of alkyl group is 2 to 12 may be more preferred and (meth)acrylic alkyl ester whose carbon number of alkyl group is 4 to 10 may be particularly preferred from the viewpoint of giving good pressure sensitive adhesive properties. Specifically, n-butyl (meth)acrylate may be preferred, and n-butyl acrylate may be particularly preferred. These may each be used alone or two or more types may also be used in combination.

From the viewpoint of giving good pressure sensitive adhesive properties, the (meth)acrylic ester polymer (A) may preferably contain 50 mass% or more, more preferably 60 mass% or more, particularly preferably 70 mass% or more, and further preferably 80 mass% or more of the (meth)acrylic alkyl ester as a monomer unit that constitutes the polymer. Additionally or alternatively, from the viewpoint of ensuring the content of other monomers (in particular, ethylene carbonate-containing monomer), the (meth)acrylic ester polymer (A) may preferably contain 99.6 mass% or less, more preferably 99 mass% or less, particularly preferably 95 mass% or less, and further preferably 90 mass% or less of the (meth)acrylic alkyl ester.

The (meth)acrylic ester polymer (A) may also preferably contain, as a monomer that constitutes the polymer, a reactive functional group-containing monomer having a reactive functional group in the molecule. When containing a reactive functional group-containing monomer, the interaction between the (meth)acrylic ester polymer (A) and the ionic compound (B) is more easily exhibited, and a pseudo-crosslinked structure is more easily formed. This allows the obtained pressure sensitive adhesive to have enhanced cohesive strength and also allows the mechanical properties (strain amount, relaxation elastic modulus fluctuation value, storage elastic modulus), which will be described later, to be easily satisfied, and the step followability will be more excellent.

Preferred examples of the above reactive functional group-containing monomer include a monomer having a hydroxyl group in the molecule (hydroxyl group-containing monomer), a monomer having a carboxy group in the molecule (carboxy group-containing monomer), and a monomer having an amino group in the molecule (amino group-containing monomer). Among these, the hydroxyl group-containing monomer may be preferred from the viewpoint that the above pseudo-crosslinked structure can be easily formed. These reactive functional group-containing monomers may each be used alone or two or more types may also be used in combination.

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among these, 2-hydroxyethyl (meth)acrylate and 4-hydroxybutyl (meth)acrylate may be preferred and 2-hydroxyethyl acrylate and 4-hydroxybutyl acrylate may be particularly preferred from the viewpoint that the above pseudo-crosslinked structure can be easily formed. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. These may each be used alone or two or more types may also be used in combination.

Examples of the amino group-containing monomer include aminoethyl (meth)acrylate and n-butylaminoethyl (meth)acrylate. These may each be used alone or two or more types may also be used in combination.

The (meth)acrylic ester polymer (A) may preferably contain, as the lower limit, 0.1 mass% or more, more preferably 0.5 mass% or more, and particularly preferably 1 mass% or more of the reactive functional group-containing monomer as a monomer unit that constitutes the polymer. From another aspect, the (meth)acrylic ester polymer (A) may preferably contain, as the upper limit, 10 mass% or less, more preferably 8 mass% or less, particularly preferably 6 mass% or less, and further preferably 3 mass% or less of the reactive functional group-containing monomer as a monomer unit that constitutes the polymer. When the (meth)acrylic ester polymer (A) contains the reactive functional group-containing monomer within the above range as a monomer unit that constitutes the polymer, the above pseudo-crosslinked structure can be more easily formed. This allows the obtained pressure sensitive adhesive to have enhanced cohesive strength and also allows the mechanical properties (strain amount, relaxation elastic modulus fluctuation value, storage elastic modulus), which will be described later, to be easily satisfied, and the step followability will be more excellent. Moreover, it is excellent in suppressing the optical unevenness and also excellent in the handling ability.

The (meth)acrylic ester polymer (A) in the present embodiment may further contain other monomers as monomers that constitute the polymer. Examples of the other monomers include alicyclic structure-containing (meth)acrylic esters such as dicyclopentanyl (meth)acrylate, adamantyl (meth)acrylate, isobornyl (meth)acrylate, dicyclopentenyl (meth)acrylate, and dicyclopentenyl oxyethyl (meth)acrylate; (meth)acrylic alkoxyalkyl esters such as methoxyethyl (meth)acrylate and ethoxyethyl (meth)acrylate; non-crosslinkable acrylamides such as acrylamide and methacrylamide; (meth)acrylic esters having non-crosslinkable tertiary amino groups, such as N,N-dimethylaminoethyl (meth)acrylate and N,N-dimethylaminopropyl (meth)acrylate; vinyl acetate; and styrene. These may each be used alone or two or more types may also be used in combination.

The polymerization form of the (meth)acrylic ester polymer (A) in the present embodiment may be a random polymer or may also be a block polymer. The (meth)acrylic ester polymer (A) can be obtained by polymerizing any of the above-described monomers using an ordinary method. For example, the (meth)acrylic ester polymer (A) can be prepared by polymerization, such as using an emulsion polymerization method, a solution polymerization method, a suspension polymerization method, a bulk polymerization method, or an aqueous solution polymerization method. Among these, the solution polymerization method performed in an organic solvent may be preferably adopted for preparing the (meth)acrylic ester polymer (A) from the viewpoint of stability during polymerization and ease of handling during use.

The weight-average molecular weight of the (meth)acrylic ester polymer (A) may be preferably 100,000 or more, more preferably 300,000 or more, particularly preferably 500,000 or more, and further preferably 650,000 or more. From another aspect, the weight-average molecular weight of the (meth)acrylic ester polymer (A) may be preferably 2,000,000 or less, more preferably 1,500,000 or less, particularly preferably 1,000,000 or less, and further preferably 800,000 or less. When the weight-average molecular weight of the (meth)acrylic ester polymer (A) falls within the above range, the mechanical properties (strain amount, relaxation elastic modulus fluctuation value, storage elastic modulus), which will be described later, can be easily satisfied, and the step followability will be more excellent. Moreover, it is excellent in suppressing the optical unevenness and also excellent in the handling ability. As used in the present specification, the weight-average molecular weight refers to a standard polystyrene equivalent value that is measured using a gel permeation chromatography (GPC) method.

The pressure sensitive adhesive composition P according to the present embodiment may contain one type or two or more types of the above-described (meth)acrylic ester polymer (A). Additionally or alternatively, the pressure sensitive adhesive composition P according to the present embodiment may contain another (meth)acrylic ester polymer together with the above-described (meth)acrylic ester polymer (A).

### 2) Ionic Compound (B)

The ionic compound in the present specification refers to a compound in which a cation and an anion are bound together mainly by electrostatic attraction. The ionic compound (B) in the present embodiment may be liquid (ionic liquid) or solid (ionic solid) at room temperature.

Examples of the ionic compound (B) include an alkali metal salt, an alkaline-earth metal salt, a nitrogen-containing onium salt, a sulfur-containing onium salt, and a phosphorus-containing onium salt. Among these, an alkali metal salt or an alkaline-earth metal salt may be preferred and an alkali metal salt may be particularly preferred from the viewpoint of easily forming the above pseudo-crosslinked structure with the (meth)acrylic ester polymer (A). One type of the ionic compound (B) may be used alone or two or more types may also be used in combination.

Specific examples of the alkali metal salt include potassium bis(fluorosulfonyl)imide, lithium bis(fluorosulfonyl)imide, potassium bis(fluoromethanesulfonyl)imide, lithium bis(fluoromethanesulfonyl)imide, potassium bis(trifluoromethanesulfonyl)imide, and lithium bis(trifluoromethanesulfonyl)imide. Among these, lithium bis(trifluoromethanesulfonyl)imide may be preferred from the viewpoint of easily forming the above pseudo-crosslinked structure.

The content of the ionic compound (B) in the pressure sensitive adhesive composition may be preferably 0.1 mass parts or more, more preferably 0.2 mass parts or more, particularly preferably 0.3 mass parts or more, and further preferably 0.4 mass parts or more with respect to 100 mass parts of the (meth)acrylic ester polymer (A). From another aspect, the content of the ionic compound (B) may be preferably 2 mass parts or less, more preferably 1.5 mass parts or less, particularly preferably 1 mass part or less, and further preferably 0.7 mass parts or less with respect to 100 mass parts of the (meth)acrylic ester polymer (A) . When the content of the ionic compound (B) falls within the above range, the degree of the above pseudo-crosslinking is appropriate. This allows the obtained pressure sensitive adhesive to easily satisfy the mechanical properties (strain amount, relaxation elastic modulus fluctuation value, storage elastic modulus), which will be described later, and the step followability will be more excellent. Moreover, it is excellent in suppressing the optical unevenness and also excellent in the handling ability.

### 3) Various Additives

If desired, the pressure sensitive adhesive composition P can contain one or more of various additives, such as a crosslinker, a silane coupling agent, an anticorrosive, an ultraviolet absorber, a tackifier, an antioxidant, a light stabilizer, a softening agent, and a refractive index adjuster, which are commonly used in an acrylic-based pressure sensitive adhesive. The additives which constitute the pressure sensitive adhesive composition P are deemed not to include a polymerization solvent or a diluent solvent, which will be described later.

As described previously, the pressure sensitive adhesive composition P forms a pseudo-crosslinked structure and therefore does not require a crosslinker. This eliminates the need for aging when obtaining the pressure sensitive adhesive. From such a viewpoint, the pressure sensitive adhesive composition P preferably does not contain a crosslinker.

However, the pressure sensitive adhesive composition P does not exclude those containing a crosslinker. When the pressure sensitive adhesive composition P contains a crosslinker, the content of the crosslinker may be preferably 0.1 mass parts or less, more preferably 0.04 mass parts or less, and particularly preferably 0.01 mass parts or less with respect to 100 mass parts of the (meth)acrylic ester polymer (A). Examples of the crosslinker as referred to herein include crosslinkers that form a covalent bond with the (meth)acrylic ester polymer (A), such as an isocyanate-based crosslinker, an epoxy-based crosslinker, and an amine-based crosslinker.

### Preparation of Pressure Sensitive Adhesive Composition

The pressure sensitive adhesive composition P can be prepared through preparing the (meth)acrylic ester polymer (A) and mixing the obtained (meth)acrylic ester polymer (A) with the ionic compound (B), and, if desired, adding additives, etc. thereto.

The (meth)acrylic ester polymer (A) can be prepared by polymerizing a mixture of the monomers which constitute the polymer using a commonly-used radical polymerization method. Polymerization of the (meth)acrylic ester polymer (A) may be preferably carried out by a solution polymerization method, if desired, using a polymerization initiator. However, the present invention is not limited to this, and polymerization may be carried out without a solvent. Examples of the polymerization solvent include ethyl acetate, n-butyl acetate, isobutyl acetate, toluene, acetone, hexane, and methyl ethyl ketone and two or more types thereof may also be used in combination.

Examples of the polymerization initiator include azo-based compounds and organic peroxides and two or more types thereof may also be used in combination. Examples of the azo-based compounds include 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxides include benzoyl peroxide, t-butyl perbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxybivalate, (3,5,5-trimethylhexanoyl)peroxide, dipropionyl peroxide, and diacetyl peroxide.

In the above polymerization step, the weight-average molecular weight of the polymer to be obtained can be adjusted by compounding a chain transfer agent such as 2-mercaptoethanol.

After the (meth)acrylic ester polymer (A) is obtained, the pressure sensitive adhesive composition P (coating solution) diluted with a solvent may be obtained through adding the ionic compound (B) and, if desired, a diluting solvent, additives, etc. to the solution of the (meth)acrylic ester polymer (A) and sufficiently mixing them. If any of the above components is in the form of a solid, or if precipitation occurs when the component is mixed with another component in an undiluted state, the component may be preliminarily dissolved in or diluted with a diluting solvent alone and then mixed with the other component.

Examples of the above diluting solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity is within any range in which the coating is possible. For example, the pressure sensitive adhesive composition P may be diluted to a concentration of 10 to 60 mass%. When obtaining the coating solution, the addition of a diluting solvent or the like is not a necessary condition, and the diluting solvent may not be added if the pressure sensitive adhesive composition P has a viscosity or the like that enables the coating. In this case, the pressure sensitive adhesive composition P may be a coating solution in which the polymerization solvent itself for the (meth)acrylic ester polymer (A) is used as a diluting solvent.

### Pressure Sensitive Adhesive

The pressure sensitive adhesive according to an embodiment of the present invention can be obtained from the pressure sensitive adhesive composition P according to the previously described embodiment, and specifically can be obtained by crosslinking (pseudo-crosslinking) the previously described pressure sensitive adhesive composition P.

Crosslinking of the pressure sensitive adhesive composition P can be usually performed by heat treatment. Drying treatment when volatilizing a diluent solvent and the like from the coating film of the pressure sensitive adhesive composition P applied to a desired object can also serve as the above heat treatment.

The heating temperature of the heat treatment may be preferably 50° C. to 150° C. and particularly preferably 70° C. to 120° C. The heating time may be preferably 10 seconds to 10 minutes and particularly preferably 50 seconds to 5 minutes.

When the pressure sensitive adhesive composition P contains a crosslinker, it may be preferred to provide an aging period after the above heat treatment in order to complete the crosslinking reaction, but the pressure sensitive adhesive composition P according to the present embodiment does not need to contain a crosslinker, and in this case the aging period is unnecessary. This allows the productivity of pressure sensitive adhesive sheets to be improved.

### Pressure Sensitive Adhesive Sheet

The pressure sensitive adhesive sheet according to an embodiment of the present invention includes at least a pressure sensitive adhesive layer and may be preferably a pressure sensitive adhesive sheet in which a release sheet is laminated on one surface of the pressure sensitive adhesive layer or release sheets are laminated on both surfaces of the pressure sensitive adhesive layer.

The pressure sensitive adhesive sheet according to the present embodiment may be preferably used for bonding a member and another member and, in particular, may be preferably used when at least one of the member and the other member has one or more steps at least on the surface on the pressure sensitive adhesive layer side. Preferred examples of the above members include display body structural members, and therefore the pressure sensitive adhesive sheet according to the present embodiment may be preferably used for optical applications, but the present invention is not limited to this.

In the pressure sensitive adhesive sheet according to an embodiment of the present invention, the above pressure sensitive adhesive layer is composed of the above-described pressure sensitive adhesive. The pressure sensitive adhesive layer or the pressure sensitive adhesive constituting the pressure sensitive adhesive layer may preferably have the physical properties described below.

The pressure sensitive adhesive sheet according to another embodiment of the present invention may be preferably as follows: the strain amount of a pressure sensitive adhesive constituting the above pressure sensitive adhesive layer is 50% or more and 260% or less at 25° C. after 1210 seconds from when applying a stress of 7950 Pa to the pressure sensitive adhesive; and, provided that the maximum relaxation elastic modulus value of the pressure sensitive adhesive constituting the above pressure sensitive adhesive layer measured when straining the pressure sensitive adhesive by 10% in accordance with JIS K7244-1 is a maximum relaxation elastic modulus G(t)ₘₐₓ (MPa) and the minimum relaxation elastic modulus value measured while continuing to strain the above pressure sensitive adhesive by 10% until 3757 seconds after the maximum relaxation elastic modulus G(t)ₘₐₓ is measured is a minimum relaxation elastic modulus G(t)ₘᵢₙ (MPa), a relaxation elastic modulus fluctuation value Δlog(G(t)) calculated from the following Formula (X) is 1.2 or more and 2.0 or less.

$$Δ \text{log} \left(\text{G} \left(\text{t}\right)\right) = log \left(\text{G} {\left(\text{t}\right)}_{\text{max}}\right) - log \left(\text{G} {\left(\text{t}\right)}_{min}\right)$$

Details of the method of measuring the strain amount (%) and the method of measuring the relaxation elastic modulus G(t) are as described in the testing examples, which will be described later. The phrase “when applying a stress of 7950 Pa to the pressure sensitive adhesive” refers to the time when a stress is applied to the pressure sensitive adhesive and the stress reaches 7950 Pa.

In the pressure sensitive adhesive sheet according to the present embodiment, the pressure sensitive adhesive constituting the pressure sensitive adhesive layer has the above physical properties thereby to allow the pressure sensitive adhesive layer to be easily deformed, and the step followability is excellent from the initial stage to under high-temperature and high-humidity conditions because excellent stress relaxation properties are exhibited. Moreover, it is excellent in suppressing the optical unevenness and also excellent in the handling ability.

In particular, provided that the above strain amount is 50% or more, when an external force is applied to the pressure sensitive adhesive layer, moderate strain occurs to allow the pressure sensitive adhesive layer to be easily deformed, and the pressure sensitive adhesive layer is likely to be excellent in the step followability in the initial stage and after autoclave treatment. Moreover, when the above strain amount is 50% or more, the relaxation elastic modulus fluctuation value Δlog(G(t)) tends to increase and easily satisfies a desired range. From such a viewpoint, the above strain amount may be more preferably 100% or more, particularly preferably 150% or more, and further preferably 180% or more.

From another aspect, in particular, when the above strain amount is 260% or less, the pressure sensitive adhesive exhibits high cohesive properties and is excellent in the step followability even under high-temperature and high-humidity conditions. Moreover, the cohesive failure of the pressure sensitive adhesive is less likely to occur, and the occurrence of adhesive residue or the like can be suppressed when the pressure sensitive adhesive sheet is removed from an adherend. Furthermore, the obtained pressure sensitive adhesive sheet is excellent in the handling ability. From such a viewpoint, the above strain amount may be more preferably 240% or less, particularly preferably 225% or less, and further preferably 200% or less.

On the other hand, in particular, when the above relaxation elastic modulus fluctuation value Δlog(G(t)) is 1.2 or more, the stress relaxation properties are excellent. Therefore, after the pressure sensitive adhesive sheet is attached to a step of the adherend, the stress relaxation tends to proceed inside the pressure sensitive adhesive, and residual stress particularly in the vicinity of the step is easily relaxed. This can suppress the occurrence of floating and delamination, which are induced by the residual stress when the pressure sensitive adhesive sheet is attached to the step, even under high-temperature and high-humidity conditions, and excellent step followability is exhibited. From such a viewpoint, the above relaxation elastic modulus fluctuation value Δlog(G(t)) may be more preferably 1.3 or more, particularly preferably 1.4 or more, and further preferably 1.44 or more. .

From another aspect, in particular, when the elastic modulus fluctuation value Δlog(G(t)) is 2.0 or less, the pressure sensitive adhesive easily exhibits appropriate stress relaxation properties. From such a viewpoint, the above elastic modulus fluctuation value Δlog(G(t)) may be more preferably 1.8 or less, particularly preferably 1.6 or less, and further preferably 1.5 or less.

The gel fraction of the pressure sensitive adhesive constituting the above pressure sensitive adhesive layer may be preferably 0% or more, more preferably 0.4% or more, particularly preferably 0.8% or more, and further preferably 1.2% or more as the lower limit. From another aspect, the above gel fraction may be preferably 60% or less, more preferably 40% or less, particularly preferably 20% or less, further preferably 10% or less, and most preferably 3% or less as the upper limit. When the gel fraction of the pressure sensitive adhesive constituting the above pressure sensitive adhesive layer falls within the above range, the above strain amount and elastic modulus fluctuation value Δlog(G(t)) can be easily adjusted within the previously described ranges. Moreover, when the gel fraction is 3% or less, it can be said that the pressure sensitive adhesive is pseudo-crosslinked, and the step followability in the initial stage is more excellent. The measurement method for the gel fraction of the pressure sensitive adhesive is as described in the testing example, which will be described later.

The storage elastic modulus (G′) at 25° C. of the pressure sensitive adhesive constituting the above pressure sensitive adhesive layer may be preferably 0.01 MPa or more, more preferably 0.05 MPa or more, particularly preferably 0.08 MPa or more, and further preferably 0.1 MPa or more as the lower limit. When the lower limit of the storage elastic modulus (G′) at 25° C. is as the above, the previously described strain amount and elastic modulus fluctuation value Δlog(G(t)) can easily satisfy the previously described ranges, and the obtained pressure sensitive adhesive is more excellent in the step followability under high-temperature and high-humidity conditions. Moreover, the adhesive strength, which will be described later, can be easily satisfied. The testing method for the storage elastic modulus (G′) is as described in the testing example, which will be described later.

On the other hand, the storage elastic modulus (G′) at 25° C. of the pressure sensitive adhesive constituting the above pressure sensitive adhesive layer may be preferably 1 MPa or less, more preferably 0.8 MPa or less, particularly preferably 0.5 MPa or less, and further preferably 0.2 MPa or less as the upper limit. When the upper limit of the storage elastic modulus (G′) at 25° C. is as the above, the previously described strain amount and elastic modulus fluctuation value Δlog(G(t)) can easily satisfy the previously described ranges, and the obtained pressure sensitive adhesive is more excellent in the step followability in the initial stage. Moreover, the adhesive strength, which will be described later, can be easily satisfied.

The storage elastic modulus (G′) at 50° C. of the pressure sensitive adhesive constituting the above pressure sensitive adhesive layer may be preferably 0.01 MPa or more, more preferably 0.02 MPa or more, particularly preferably 0.03 MPa or more, and further preferably 0.04 MPa or more as the lower limit. When the lower limit of the storage elastic modulus (G′) at 50° C. is as the above, the previously described strain amount and elastic modulus fluctuation value Δlog(G(t)) can easily satisfy the previously described ranges, and the obtained pressure sensitive adhesive is more excellent in the step followability under high-temperature and high-humidity conditions. Moreover, the adhesive strength, which will be described later, can be easily satisfied.

On the other hand, the storage elastic modulus (G′) at 50° C. of the pressure sensitive adhesive constituting the above pressure sensitive adhesive layer may be preferably 1 MPa or less, more preferably 0.5 MPa or less, particularly preferably 0.3 MPa or less, and further preferably 0.1 MPa or less as the upper limit. When the upper limit of the storage elastic modulus (G′) at 50° C. is as the above, the previously described strain amount and elastic modulus fluctuation value Δlog(G(t)) can easily satisfy the previously described ranges, and the obtained pressure sensitive adhesive is more excellent in the step followability in the initial stage, in particular, the step followability after lamination using an autoclave or the like. Moreover, the adhesive strength, which will be described later, can be easily satisfied.

The storage elastic modulus (G′) at 85° C. of the pressure sensitive adhesive constituting the above pressure sensitive adhesive layer may be preferably 0.01 MPa or more, particularly preferably 0.015 MPa or more, and further preferably 0.02 MPa or more as the lower limit. When the lower limit of the storage elastic modulus (G′) at 85° C. is as the above, the previously described strain amount and elastic modulus fluctuation value Δlog(G(t)) can easily satisfy the previously described ranges, and the obtained pressure sensitive adhesive is more excellent in the step followability under high-temperature and high-humidity conditions. Moreover, the adhesive strength, which will be described later, can be easily satisfied.

On the other hand, the storage elastic modulus (G′) at 85° C. of the pressure sensitive adhesive constituting the above pressure sensitive adhesive layer may be preferably 1 MPa or less, more preferably 0.5 MPa or less, particularly preferably 0.1 MPa or less, and further preferably 0.03 MPa or less as the upper limit. When the upper limit of the storage elastic modulus (G′) at 85° C. is as the above, the previously described strain amount and elastic modulus fluctuation value Δlog(G(t)) can easily satisfy the previously described ranges, and the obtained pressure sensitive adhesive is more excellent in the step followability under high-temperature and high-humidity conditions. Moreover, the adhesive strength, which will be described later, can be easily satisfied.

The adhesive strength of the pressure sensitive adhesive sheet according to the present embodiment to soda-lime glass may be preferably more than 1 N/25 mm, more preferably 5 N/25 mm or more, particularly preferably 10 N/25 mm or more, and further preferably 20 N/25 mm or more as the lower limit. When the lower limit of the adhesive strength is as the above, the step followability under high-temperature and high-humidity conditions can be more excellent. On the other hand, the upper limit of the above adhesive strength to soda-lime glass is not particularly limited, but considering the case in which reworkability may be required, the upper limit may be preferably 100 N/25 mm or less, more preferably 60 N/25 mm or less, particularly preferably 40 N/25 mm or less, and further preferably 30 N/25 mm or less.

The adhesive strength of the pressure sensitive adhesive sheet according to the present embodiment to non-alkali glass may be preferably 1 N/25 mm or more, more preferably 5 N/25 mm or more, particularly preferably 10 N/25 mm or more, and further preferably 20 N/25 mm or more as the lower limit. When the lower limit of the adhesive strength is as the above, the step followability under high-temperature and high-humidity conditions can be more excellent. On the other hand, the upper limit of the above adhesive strength to non-alkali glass is not particularly limited, but considering the case in which reworkability may be required, the upper limit may be preferably 100 N/25 mm or less, more preferably 60 N/25 mm or less, particularly preferably 40 N/25 mm or less, and further preferably 30 N/25 mm or less.

The above adhesive strength refers basically to a peel strength that is measured using a method of 180° peeling in accordance with JIS Z0237: 2009, and a specific testing method is as described in the testing example, which will be described later.

The pressure sensitive adhesive or pressure sensitive adhesive layer having the above physical properties can be preferably obtained using the previously described pressure sensitive adhesive composition P, but the present invention is not limited to this.

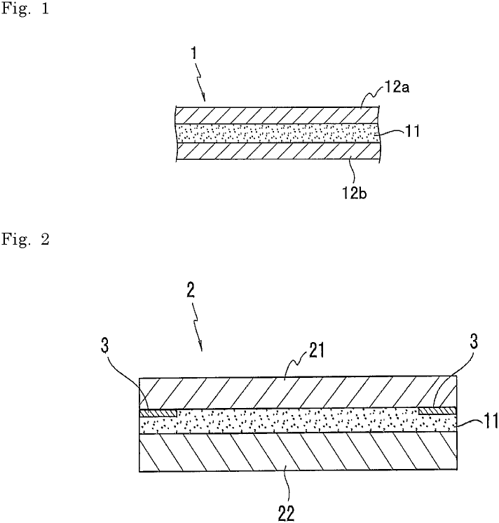

Here, FIG. 1 illustrates a specific configuration as an example of the pressure sensitive adhesive sheet according to the present embodiment. As illustrated in FIG. 1, a pressure sensitive adhesive sheet 1 according to an embodiment is composed of two release sheets 12a and 12b and an active energy ray curable pressure sensitive adhesive layer 11 that is interposed between the two release sheets 12a and 12b so as to be in contact with release surfaces of the two release sheets 12a and 12b. The release surface of a release sheet in the present specification refers to a surface having releasability in the release sheet, and examples of the release surface include both a surface subjected to release treatment and a surface that exhibits releasability even without being subjected to release treatment.

### 1. Each Member

### 1-1. Pressure Sensitive Adhesive Layer

The pressure sensitive adhesive layer 11 of the pressure sensitive adhesive sheet 1 according to the present embodiment may have the previously described composition or physical properties.

The thickness (value measured in accordance with JIS K7130) of the pressure sensitive adhesive layer 11 in the present embodiment may be preferably 1 µm or more, more preferably 5 µm or more, particularly preferably 10 µm or more, and further preferably 20 µm or more. This allows the pressure sensitive adhesive layer 11 to easily exhibit the previously described adhesive strength and to have more excellent step followability. From another aspect, the thickness of the pressure sensitive adhesive layer 11 may be preferably 100 µm or less, more preferably 75 µm or less, particularly preferably 50 µm or less, and further preferably 30 µm or less. This can suppress defects in the appearance, such as indentations and dents on the pressure sensitive adhesive layer 11. Moreover, the thickness of a laminate (such as a display body) obtained using the pressure sensitive adhesive sheet 1 can be reduced. The pressure sensitive adhesive layer 11 may be formed as a single layer or may also be formed by laminating a plurality of layers.

### 1-2. Release Sheets

The release sheets 12a and 12b are to protect the pressure sensitive adhesive layer 11 until the use of the pressure sensitive adhesive sheet 1 and are removed when using the pressure sensitive adhesive sheet 1 (pressure sensitive adhesive layer 11). In the pressure sensitive adhesive sheet 1 according to the present embodiment, one or both of the release sheets 12a and 12b may be unnecessary.

Examples of the release sheets 12a and 12b for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene-(meth)acrylic acid polymer films, ethylene-(meth)acrylic ester polymer films, polystyrene films, polycarbonate films, polyimide films, and fluorine resin films. Crosslinked films thereof may also be used. Laminate films each obtained by laminating a plurality of such films may also be used.

It may be preferred to perform release treatment for the release surfaces of the above release sheets 12a and 12b. Examples of a release agent to be used for the release treatment include alkyd-based, silicone-based, fluorine-based, unsaturated polyester-based, polyolefin-based, and wax-based release agents.

The thickness of the release sheets 12a and 12b is not particularly limited, but may be usually about 20 to 150 µm.

### 2. Production of Pressure Sensitive Adhesive Sheet

An exemplary method of producing the pressure sensitive adhesive sheet 1 may include coating the release surface of one release sheet 12a (or 12b) with a coating solution of the above pressure sensitive adhesive composition P, performing heat treatment to crosslink the pressure sensitive adhesive composition P to form the pressure sensitive adhesive layer 11, and then overlapping the release surface of the other release sheet 12b (or 12a) on the pressure sensitive adhesive layer 11. The above pressure sensitive adhesive sheet 1 can thus be obtained. Conditions for the heat treatment are as previously described. The pressure sensitive adhesive sheet 1 can be produced without aging by using the pressure sensitive adhesive composition P for formation of the pressure sensitive adhesive layer 11.

Another exemplary method of producing the pressure sensitive adhesive sheet 1 may include coating the release surface of one release sheet 12a with a coating solution of the above pressure sensitive adhesive composition P and performing heat treatment to crosslink the pressure sensitive adhesive composition P to form a pressure sensitive adhesive layer, thus obtaining the release sheet 12a with the pressure sensitive adhesive layer. The method may further include coating the release surface of the other release sheet 12b with the coating solution of the above pressure sensitive adhesive composition P and performing heat treatment to crosslink the pressure sensitive adhesive composition P to form another pressure sensitive adhesive layer, thus obtaining the release sheet 12b with the other pressure sensitive adhesive layer. Then, the release sheet 12a with the pressure sensitive adhesive layer and the release sheet 12b with the other pressure sensitive adhesive layer are bonded so that both the pressure sensitive adhesive layers are in contact with each other, thus forming the pressure sensitive adhesive layer 11. The above pressure sensitive adhesive sheet 1 can thus be obtained. According to this production example, even when the pressure sensitive adhesive layer 11 is thick, stable production is possible.

Examples of the method of coating with the above coating solution of the pressure sensitive adhesive composition P include a bar coating method, a knife coating method, a roll coating method, a blade coating method, a die coating method, and a gravure coating method.

### Laminate

The laminate according to an embodiment of the present invention includes a display body structural member, another display body structural member, and a pressure sensitive adhesive layer that bonds these display body structural members to each other, and the pressure sensitive adhesive layer is formed of the previously described pressure sensitive adhesive layer of the pressure sensitive adhesive sheet. This laminate may be a display body (display panel) or a member thereof.

At least one of the above display body structural member and the above other display body structural member may preferably have one or more steps on the surface on the side bonded by the above pressure sensitive adhesive layer, and the one or more steps may be preferably those due to a printed layer. The above pressure sensitive adhesive layer is excellent in the step followability from the initial stage to under high-temperature and high-humidity conditions; therefore, even when the above laminate is placed under high-temperature and high-humidity conditions (e.g., 85° C., 85% RH, 96 hours), the occurrence of air bubbles, floating, delamination, etc. in the vicinity of the steps can be suppressed. Moreover, the occurrence of optical unevenness in the vicinity of the steps can also be suppressed because the above pressure sensitive adhesive layer is excellent in suppressing the optical unevenness.

FIG. 2 illustrates a specific configuration as an example of the laminate according to the present embodiment.

As illustrated in FIG. 2, a laminate 2 according to the present embodiment includes a first display body structural member 21, a second display body structural member 22, and a pressure sensitive adhesive layer 11 that is located and interposed between the first display body structural member 21 and the second display body structural member 22. In the laminate 2 according to the present embodiment, the first display body structural member 21 has steps on the surface on the pressure sensitive adhesive layer 11 side, specifically steps due to the presence or absence of a printed layer 3.

The laminate 2 may be, for example, a member that constitutes a part of a display body such as a liquid crystal (LCD) display, a light emitting diode (LED) display, an organic electroluminescence (organic EL) display, or electronic paper or may also be the display body itself. The display body may be a touch panel or may also be a flexible display that is bent repeatedly.

The pressure sensitive adhesive layer 11 in the above laminate 2 may be formed of the previously described pressure sensitive adhesive layer 11 of the pressure sensitive adhesive sheet 1 and may be preferably the pressure sensitive adhesive layer 11 itself.

The first display body structural member 21 and the second display body structural member 22 are not particularly limited, provided that the pressure sensitive adhesive layer 11 can be adhered thereto. The first display body structural member 21 and the second display body structural member 22 may be made of the same material or may also be made of different materials.

The first display body structural member 21 may be preferably a protective panel made of a glass plate, a plastic plate, or the like or a laminate that includes a glass plate or a plastic plate. In this case, the printed layer 3 is generally formed in the shape of a frame on the pressure sensitive adhesive layer 11 side of the first display body structural member 21.

The above glass plate is not particularly limited, and examples thereof include chemically strengthened glass, non-alkali glass, quartz glass, soda-lime glass, barium/strontium-containing glass, aluminosilicate glass, lead glass, borosilicate glass, and barium borosilicate glass. The thickness of the glass plate is not particularly limited, but may be usually 0.1 to 5 mm and preferably 0.2 to 2 mm.

The above plastic plate is not particularly limited, and examples thereof include acrylic plates and polycarbonate plates. The thickness of the plastic plate is not particularly limited, but may be usually 0.2 to 5 mm, preferably 0.4 to 3 mm, particularly preferably 0.6 to 2.5 mm, and further preferably 0.8 to 2.1 mm.

One surface or both surfaces of the above glass plate or plastic plate may be provided with various functional layers (such as a transparent conductive film, a metal layer, a silica layer, a hard coat layer, and an antiglare layer) or may also be laminated with an optical member. The transparent conductive film and the metal layer may be patterned.

The second display body structural member 22 may be preferably an optical member, a display body module (e.g., a liquid crystal (LCD) module, a light emitting diode (LED) module, an organic electroluminescence (organic EL) module, or the like), an optical member as a part of the display body module, or a laminate including the display body module, which are to be bonded to the first display body structural member 21.

Examples of the above optical member include an anti-scattering film, a polarizing plate (polarizing film), a polarizer, a retardation plate (retardation film), a viewing angle compensation film, a brightness enhancement film, a contrast enhancement film, a liquid crystal polymer film, a diffusion film, a transflective film, and a transparent conductive film. Examples of the anti-scattering film include a hard coat film in which a hard coat layer is formed on one surface of a base material film.

The material which constitutes the printed layer 3 is not particularly limited, and known materials for printing may be used. The lower limit of the thickness of the printed layer 3, that is, the lower limit of the height of steps, may be preferably 3 µm or more, more preferably 5 µm or more, particularly preferably 7 µm or more, and most preferably 10 µm or more. When the lower limit is as the above, it is possible to sufficiently ensure the concealability such as making the electric wiring invisible from the viewer side. From another aspect, the upper limit may be preferably thinner than the thickness of the pressure sensitive adhesive layer, preferably 80 µm or less, more preferably 50 µm or less, particularly preferably 25 µm or less, and further preferably 20 µm or less. When the upper limit is as the above, it is possible to prevent the pressure sensitive adhesive layer 11 from deteriorating in the step followability to the printed layer 3. Moreover, the thickness of the obtained laminate 2 can be reduced.

To produce the above laminate 2, in an example, one release sheet 12a of the pressure sensitive adhesive sheet 1 is removed, and the exposed pressure sensitive adhesive layer 11 of the pressure sensitive adhesive sheet 1 is bonded to the surface of the first display body structural member 21 on the side on which the printed layer 3 is present. In this operation, the occurrence of a gap or floating in the vicinity of the steps due to the printed layer 3 can be suppressed because the pressure sensitive adhesive layer 11 is excellent in the step followability.

After that, the other release sheet 12b is removed from the pressure sensitive adhesive layer 11 of the pressure sensitive adhesive sheet 1, and the exposed pressure sensitive adhesive layer 11 of the pressure sensitive adhesive sheet 1 and the second display body structural member 22 are bonded to each other to obtain the laminate 2. In another example, the bonding order of the first display body structural member 21 and the second display body structural member 22 may be changed.

When the laminate 2 is obtained as described above, autoclave treatment may be performed in order to allow the pressure sensitive adhesive layer 11 to tightly adhere to the first display body structural member 21 and the second display body structural member 22. Also in this stage, the occurrence of air bubbles, floating, etc. in the vicinity of the steps can be suppressed because the pressure sensitive adhesive layer 11 is excellent in the step followability. Moreover, the occurrence of optical unevenness in the vicinity of the steps can also be suppressed because the pressure sensitive adhesive layer 11 is excellent in suppressing the optical unevenness.

The autoclave treatment may be performed by an ordinary method, and for example, it may be preferred to perform the treatment at a temperature of 40° C. to 80° C. and a pressure of 0.3 to 1 MPa for 5 to 60 minutes.

In above the laminate 2, the pressure sensitive adhesive layer 11 is excellent in the step followability; therefore, even when the laminate 2 is placed, for example, under high-temperature and high-humidity conditions (e.g., 85° C., 85% RH, 96 hours), the occurrence of air bubbles, floating, delamination, etc. in the vicinity of the steps can be suppressed. Moreover, the occurrence of optical unevenness in the vicinity of the steps can also be suppressed because the above pressure sensitive adhesive layer 11 is excellent in suppressing the optical unevenness.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

For example, one or both of the release sheets 12a and 12b in the pressure sensitive adhesive sheet 1 may be omitted, and one or more desired optical members may be laminated as substitute for the release sheets 12a and/or 12b. Moreover, the first display body structural member 21 may not have the printed layer 3 (steps) or may have one or more steps other than the printed layer 3. Furthermore, not only the first display body structural member 21 but also the second display body structural member 22 may have one or more steps on the pressure sensitive adhesive layer 11 side.

### EXAMPLES

Hereinafter, the present invention will be described further specifically with reference to examples, etc., but the scope of the present invention is not limited to these examples, etc.

### Example 1

### 1. Preparation of (Meth)Acrylic Ester Polymer (A)

The (meth)acrylic ester polymer (A) was prepared by using a solution polymerization method to copolymerize 84 mass parts of n-butyl acrylate, 15 mass parts of (2-oxo-1,3-dioxolan-4-yl)methyl methacrylate as an ethylene carbonate-containing monomer, and 1 mass part of 4-hydroxybutyl acrylate. The molecular weight of the (meth)acrylic ester polymer (A) was measured by the method, which will be described later. The weight-average molecular weight (Mw) was 750,000.

### 2. Preparation of Pressure Sensitive Adhesive Composition

The coating solution of a pressure sensitive adhesive composition was obtained through mixing and sufficiently stirring 100 mass parts (solid content equivalent, here and hereinafter) of the (meth)acrylic ester polymer (A) obtained in the above step 1 and 0.5 mass parts of lithium bis(trifluoromethanesulfonyl)imide (LiTFSI) diluted with methyl ethyl ketone as the ionic compound (B) and diluting the mixture with methyl ethyl ketone. The above LiTFSI was compounded after diluting it with methyl ethyl ketone to a solid concentration of 10 mass%.

### 3. Production of Pressure Sensitive Adhesive Sheet

The release-treated surface of a tight release sheet (available from LINTEC Corporation, product name “SP-PET382150”) obtained by release-treating one surface of a polyethylene terephthalate film with a silicone-based release agent was coated with the obtained coating solution of the pressure sensitive adhesive composition by using a knife coater. Then, the coating layer was heat-treated at 90° C. for 1 minute to form a pressure sensitive adhesive layer.

Subsequently, the pressure sensitive adhesive layer on the tight release sheet obtained as above and an easy release sheet (available from LINTEC Corporation, product name “SP-PET381130”) obtained by release-treating one surface of a polyethylene terephthalate film with a silicone-based release agent were bonded to each other so that the release-treated surface of the easy release sheet was in contact with the pressure sensitive adhesive layer, thus producing a pressure sensitive adhesive sheet having the pressure sensitive adhesive layer of a thickness of 25 µm, i.e., a pressure sensitive adhesive sheet having a configuration of tight release sheet/pressure sensitive adhesive layer (thickness: 25 µm)/easy release sheet.

The thickness of the pressure sensitive adhesive layer is a value measured using a constant-pressure thickness meter (available from TECLOCK Co., Ltd., product name “PG-02”) in accordance with JIS K7130.

Here, Table 1 lists the formulations (solid content equivalents) of the pressure sensitive adhesive compositions when the (meth)acrylic ester polymer (A) is 100 mass parts (solid content equivalent). Details of the simplified names listed in Table 1 and additional information are as follows.

### (Meth)Acrylic Ester Polymer (A)

BA: n-butyl acrylate
CARBOM: (2-oxo-1,3-dioxolan-4-yl)methyl methacrylate
4HBA: 4-hydroxybutyl acrylate

### Ionic Compound (B)

lithium bis(trifluoromethanesulfonyl)imide (LiTFSI)

### Crosslinker

Trimethylolpropane-modified xylylene diisocyanate (available from Soken Chemical & Engineering Co., Ltd., product name “TD-75”)

### Comparative Examples 1 and 3

Pressure sensitive adhesive sheets were produced in the same manner as in Example 1 except that the type and ratio of each monomer constituting the (meth)acrylic ester polymer (A) and the compounding amount of the ionic compound (B) were as listed in Table 1.

### Comparative Example 2

The coating solution of a pressure sensitive adhesive composition was obtained through mixing and sufficiently stirring 100 mass parts of the (meth)acrylic ester polymer (A) obtained in the step 1 of Example 1 and 0.22 mass parts of trimethylol propane-modified xylylene diisocyanate (available from Soken Chemical & Engineering Co., Ltd., product name “TD-75”) as a crosslinker and diluting the mixture with methyl ethyl ketone.

The release-treated surface of a tight release sheet (available from LINTEC Corporation, product name “SP-PET382150”) obtained by release-treating one surface of a polyethylene terephthalate film with a silicone-based release agent was coated with the obtained coating solution of the pressure sensitive adhesive composition by using a knife coater. Then, the coating solution was heat-treated at 90° C. for 1 minute to form a coating layer.

Subsequently, the coating layer on the tight release sheet obtained as above and an easy release sheet (available from LINTEC Corporation, product name “SP-PET381130”) obtained by release-treating one surface of a polyethylene terephthalate film with a silicone-based release agent were bonded to each other so that the release-treated surface of the easy release sheet was in contact with the coating layer, and aged under a condition of 23° C. and 50% RH for 7 days to produce a pressure sensitive adhesive sheet having a pressure sensitive adhesive layer of a thickness of 25 µm, i.e., a pressure sensitive adhesive sheet having a configuration of tight release sheet/pressure sensitive adhesive layer (thickness: 25 µm)/easy release sheet.

### Comparative Examples 4 and 5

Pressure sensitive adhesive sheets were produced in the same manner as in Comparative Example 2 except that the type and ratio of each monomer constituting the (meth)acrylic ester polymer (A) and the compounding amount of the ionic compound (B) were as listed in Table 1.

The previously described weight-average molecular weight (Mw) refers to a weight-average molecular weight that is measured as a polystyrene equivalent value under the following condition using gel permeation chromatography (GPC) (GPC measurement).

### Measurement Condition

GPC measurement device: HLC-8020 available from Tosoh Corporation
GPC columns (passing through in the following order): available from Tosoh Corporation
   TSK guard column HXL-H
   TSK gel GMHXL (×2)
   TSK gel G2000HXL
Solvent for measurement: tetrahydrofuran
Measurement temperature: 40° C.

### Testing Example 1 (Measurement of Gel Fraction)

Each of the pressure sensitive adhesive sheets produced in Examples and Comparative Examples was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 24 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the mesh itself. The mass at that time is M2. The gel fraction (%) is represented by (M2/M1)×100. Through this operation, the gel fraction of the pressure sensitive adhesive was derived. The results are listed in Table 2.

### Testing Example 2 (Measurement of Storage Elastic Modulus)

A laminate having a thickness of 0.8 mm was obtained by laminating a plurality of the pressure sensitive adhesive layers of the pressure sensitive adhesive sheets produced in Examples and Comparative Examples. A cylindrical body (height of 0.8 mm) having a diameter of 8 mm was punched out from the obtained laminate of the pressure sensitive adhesive layers, and this was used as a sample.

For the above sample, the dynamic viscoelasticity was measured by a torsional shear method in accordance with JIS K7244-1 using a viscoelasticity measurement device (available from Anton Paar, product name “MCR302”) under the following condition, and the storage elastic modulus (G′) (MPa) was measured at 25° C., 50° C., and 85° C. The results are listed in Table 2.
Measurement frequency: 1 Hz
Measurement temperature range: -20° C. to 150° C.
Heating rate: 3° C./min

### Testing Example 3 (Measurement of Relaxation Elastic Modulus Fluctuation Value)

A laminate having a thickness of 0.8 mm was obtained by laminating a plurality of the pressure sensitive adhesive layers of the pressure sensitive adhesive sheets produced in Examples and Comparative Examples. A cylindrical body (height of 0.8 mm) having a diameter of 8 mm was punched out from the obtained laminate of the pressure sensitive adhesive layers, and this was used as a sample.

For the above sample, a relaxation elastic modulus G(t) (MPa) was measured while continuing to strain the pressure sensitive adhesive by 10% in accordance with JIS K7244-1 using a viscoelasticity measurement device (available from Anton Paar, product name “MCR302”) under the following condition. From the measurement result, a maximum relaxation elastic modulus G(t)ₘₐₓ (MPa) was derived, and a minimum relaxation elastic modulus G(t)ₘᵢₙ (MPa) measured until 3757 seconds after the maximum relaxation elastic modulus G(t)ₘₐₓ was measured was derived.
Measurement temperature: 25° C.
Measurement points: 1000 points (logarithmic plot)

From the obtained maximum relaxation elastic modulus G(t)ₘₐₓ (MPa) and maximum relaxation elastic modulus G(t)ₘₐₓ (MPa), a relaxation elastic modulus fluctuation value Δlog(G(t)) was calculated based on the following Formula (X). The results are listed in Table 2.

$$Δ \text{log} \left(\text{G} \left(\text{t}\right)\right) = log \left(\text{G} {\left(\text{t}\right)}_{\text{max}}\right) - log \left(\text{G} {\left(\text{t}\right)}_{min}\right)$$

### Testing Example 4 (Measurement of Strain Amount)

A laminate having a thickness of 0.2 mm was obtained by laminating a plurality of the pressure sensitive adhesive layers of the pressure sensitive adhesive sheets produced in Examples and Comparative Examples. A cuboidal body (height of 0.2 mm) of 15 mm×15 mm was punched out from the obtained laminate of the pressure sensitive adhesive layers, and this was used as a sample.

For the above sample, a constant stress was continued to be applied to the sample in accordance with JIS K7244-1 using a viscoelasticity measurement device (available from Anton Paar, product name “MCR302”) under the following condition, and the strain amount (%) after 1210 seconds from when starting to apply the stress was measured. The results are listed in Table 2.
Measurement temperature: 25° C.
Measurement points: 321 points
Stress: 7950 Pa

### Testing Example 5 (Measurement of Adhesive Strength)

The easy release sheet was removed from each of the pressure sensitive adhesive sheets produced in Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET TA063,” thickness: 100 µm) to obtain a laminate of tight release sheet/pressure sensitive adhesive layer/PET film. For Comparative Example 3, a pressure sensitive adhesive sheet having a configuration of tight release sheet/pressure sensitive adhesive layer (thickness: 25 µm) was produced without using an easy release sheet when producing the pressure sensitive adhesive sheet, and the easy-adhesion layer of a PET film having the easy-adhesion layer (available from TOYOBO CO., LTD., product name “PET TA063,” thickness: 100 µm) was bonded to the exposed pressure sensitive adhesive layer to obtain a laminate of tight release sheet/pressure sensitive adhesive layer/PET film. The laminates thus obtained as above were cut into a width of 25 mm and a length of 100 mm.

The tight release sheet was removed from the above laminate under an environment of 23° C. and 50% RH, and the exposed pressure sensitive adhesive layer was bonded to each of the following two adherends and pressurized in an autoclave available from KURIHARA SEISAKUSHO Co., Ltd. at 0.5 MPa and 50° C. for 20 minutes. After that, the obtained sample was left untouched under a condition of 23° C. and 50% RH for 24 hours, and then the adhesive strength (N/25 mm) when the laminate of the PET film and the pressure sensitive adhesive layer was peeled off from the adherend was measured under a condition of a peel speed of 300 mm/min and a peel angle of 180° by using a tensile tester (available from ORIENTEC Co., LTD., product name “TENSILON”). The measurement was conducted in accordance with JIS Z0237: 2009 except for the condition described herein. The results are listed in Table 2. In the table, “CF” indicates that cohesive failure occurred in the pressure sensitive adhesive layer.

### Adherends

-Soda-lime glass plate (available from Nippon Sheet Glass Company, Ltd., product name “Soda-lime glass,” thickness: 1.1 mm)
-Non-alkali glass plate (available from Nippon Sheet Glass Company, Ltd., product name “Eagle-X,” thickness: 1.1 mm)

### Testing Example 6 (Evaluation of Handling Ability)

When removing the easy release sheet from each of the pressure sensitive adhesive sheets produced in Examples and Comparative Examples, the handling ability (handling property of the pressure sensitive adhesive sheet) was evaluated based on the following criteria. The results are listed in Table 2.
o: Upon removal, the easy release sheet was able to be easily removed without deformation, stringiness, or cohesive failure of the pressure sensitive adhesive layer.
Δ: Upon removal, the pressure sensitive adhesive layer was deformed, but it was at a level at which the easy release sheet was able to be removed without stringiness or cohesive failure of the pressure sensitive adhesive layer.
×: Upon removal, it was difficult to remove the easy release sheet due to large deformation, stringiness, or cohesive failure of the pressure sensitive adhesive layer.

### Testing Example 7 (Evaluation of Step Followability)

On the surface of a glass plate (available from NSG Precision, product name “Corning Glass Eagle XG,” length 90 mm×breadth 50 mm×thickness 0.5 mm), ultraviolet curable ink (available from Teikoku Printing Inks Mfg. Co., Ltd., product name “POS-911 ink”) was screen-printed in the shape of a frame (outer shape: length 90 mm×breadth 50 mm, width 5 mm). Then, the above ultraviolet curable ink printed was irradiated with ultraviolet rays for curing (80 W/cm², two metal halide lamps, lamp height of 15 cm, belt speed of 10 to 15 m/min) to prepare a stepped glass plate having a step due to printing (height of step: 5 µm, 10 µm, 15 µm).

The easy release sheet was removed from each of the pressure sensitive adhesive sheets produced in Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET TA063,” thickness: 100 µm). Then, the tight release sheet was removed to expose the pressure sensitive adhesive layer, the pressure sensitive adhesive layer was laminated on each stepped glass plate using a laminator (available from Fujipla, or HISAGO Co., Ltd., product name “LPD3214”) so as to cover the entire surface of the frame-shaped print, and this was used as a sample. At this stage, the step followability after lamination (immediately after attaching) was evaluated based on the following criteria. The results are listed in Table 2.

### Step Followability After Lamination

A: Air bubbles or floating/delamination was not confirmed in the vicinity of the step.

B: Air bubbles having a diameter of 0.2 mm or less were confirmed in the vicinity of the step, but floating/delamination was not confirmed.

C: Air bubbles having a diameter of more than 0.2 mm and floating/delamination were confirmed in the vicinity of the step.

After that, the above sample was subjected to autoclave treatment for 20 minutes under a condition of 50° C. and 0.5 MPa and left untouched at normal pressure, 23° C., and 50% RH for 24 hours. At this stage, the step followability after the autoclave treatment (step followability in the initial stage) was evaluated based on the following criteria. The results are listed in Table 2.

### Step Followability After Autoclave Treatment

A: Air bubbles or floating/delamination was not confirmed in the vicinity of the step.

B: Air bubbles having a diameter of 0.2 mm or less were confirmed in the vicinity of the step, but floating/delamination was not confirmed.

C: Air bubbles having a diameter of more than 0.2 mm and floating/delamination were confirmed in the vicinity of the step.

Then, the sample after the above autoclave treatment was stored for 96 hours under a high-temperature and high-humidity condition of 85° C. and 85% RH (durability test) and then taken out in an environment of 23° C. and 50% RH. Then, the pressure sensitive adhesive layer (especially the vicinity of the step due to the printed layer) was visually confirmed, and the step followability after the high-temperature and high-humidity condition was evaluated based on the following criteria. The results are listed in Table 2.

### Step Followability After High-Temperature and High-Humidity Condition

A: Air bubbles or floating/delamination was not confirmed in the vicinity of the step.

B: Air bubbles having a diameter of 0.2 mm or less were confirmed in the vicinity of the step, but floating/delamination was not confirmed.

C: Air bubbles having a diameter of more than 0.2 mm or floating/delamination was confirmed in the vicinity of the step.

### Testing Example 8 (Evaluation of Optical Unevenness)

On the surface of a glass plate (available from NSG Precision, product name “Corning Glass Eagle XG,” length 90 mm×breadth 50 mm×thickness 0.5 mm), ultraviolet curable ink (available from Teikoku Printing Inks Mfg. Co., Ltd., product name “POS-911 ink”) was screen-printed in the shape of a frame (outer shape: length 90 mm×breadth 50 mm, width 5 mm). Then, the above ultraviolet curable ink printed was irradiated with ultraviolet rays for curing (80 W/cm², two metal halide lamps, lamp height of 15 cm, belt speed of 10 to 15 m/min) to prepare a stepped glass plate having a step due to printing (height of step: 15 µm).

The easy release sheet was removed from each of the pressure sensitive adhesive sheets produced in Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET TA063,” thickness: 100 µm). Then, the tight release sheet was removed to expose the pressure sensitive adhesive layer, and the pressure sensitive adhesive layer was laminated on each stepped glass plate using a laminator (available from Fujipla, or HISAGO Co., Ltd., product name “LPD3214”) so as to cover the entire surface of the frame-shaped print. After that, it was subjected to autoclave treatment for 20 minutes under a condition of 50° C. and 0.5 MPa and left untouched at normal pressure, 23° C., and 50% RH for 24 hours, and this was used as a sample.

For the above sample, the vicinity of the step due to the printed layer was visually confirmed, and the optical unevenness was evaluated based on the following criteria. The results are listed in Table 2. Comparative Example 2 was not evaluated because the vicinity of the step was not able to be sufficiently filled after the autoclave treatment.

### Presence or Absence of Optical Unevenness

◯: Optical unevenness was not confirmed in the vicinity of the step.

×: Optical unevenness was confirmed in the vicinity of the step.

Regarding Comparative Example 3, the handling ability was poor, and it was difficult to prepare samples for performing Testing Examples 2, 3, 4, and 7, so Testing Examples 2, 3, 4, and 7 were not performed.

TABLE 1

| | (Meth)acrylic ester polymer (A) | | Ionic compound (B) | Crosslinker |
|---|---|---|---|---|
| | Composition | Mw | mass parts | mass parts |
| Example 1 | BA/CARBOM/4HBA =84/15/1 | 75 k | 0.5 | 0 |
| Comparative Example 1 | | | 0 | 0 |
| Comparative Example 2 | | | 0 | 0.22 |
| Comparative Example 3 | BA/4HBA = 99/1 | 75 k | 0.5 | 0 |
| Comparative Example 4 | | | 0 | 0.22 |
| Comparative Example 5 | | | 0.5 | 0.22 |

TABLE 2

| | Gel fraction (%) | Storage elastic modulus G′ (Mpa) | | | Relaxation elastic modulus fluctuation value Δlog G(t) | Strain amount (%) | Adhesive strength (N/25 mm) | | Handling ability | Step followability | | | Optical unevenness |
|---|---|---|---|---|---|---|---|---|---|---|---|---|---|
| | | 2.5° C. | 50° C. | 85° C. | | | Against soda-lime glass plate | Against non-alkali glass plate | | After lamination | After autoclave treatment | After high-temperature and high-humidity condition | |
| Example 1 | 1.4 | 0.11 | 0.04 | 0.02 | 1.44 | 198 | 24 | 21 | ○ | C | A | A | ○ |
| Comparative Example 1 | 0.9 | 0.11 | 0.05 | 0.02 | 1.43 | 302 | 1.4(CF) | 1.1(CF) | Δ | C | A | B | ○ |
| Comparative Example 2 | 50 | 0.13 | 0.06 | 0.02 | 1.15 | 102 | 16 | 18 | ○ | C | C | C | - |
| Comparative Example 3 | 4 | - | - | - | - | - | 13 (CF) | 11 (CF) | × | - | - | - | ◯ |
| Comparative Example 4 | 57 | 0.03 | 0.02 | 0.01 | 0.83 | 112 | 9.0 | 12 | ○ | A | A | C | × |
| Comparative Example 5 | 60 | 0.05 | 0.03 | 0.02 | 0.87 | 109 | 3.4 | 5.6 | ○ | A | A | C | × |

As found from Table 2, the pressure sensitive adhesive sheets produced in Examples are excellent in the step followability after the autoclave treatment (step followability in the initial stage) and the step followability after the high-temperature and high-humidity condition and are also excellent in suppressing the optical unevenness. Moreover, the pressure sensitive adhesive sheets produced in Examples have high adhesive strength and are excellent in the handling ability.

### INDUSTRIAL APPLICABILITY

The pressure sensitive adhesive sheet according to the present invention can be suitably used, for example, for bonding between a protective panel having a step and a desired display body structural member, etc.

### DESCRIPTION OF REFERENCE NUMERALS

1 Pressure sensitive adhesive sheet
   11 Pressure sensitive adhesive layer
   12a, 12b Release sheet
2 Laminate
   21 First display body structural member
   22 Second display body structural member
   3 Printed layer

1. A pressure sensitive adhesive composition comprising:
a (meth)acrylic ester polymer (A) containing, as a monomer unit constituting the polymer, an ethylene carbonate-containing monomer having an ethylene carbonate structure represented by Formula (1): 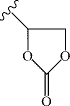
; and
an ionic compound (B).

2. The pressure sensitive adhesive composition according to claim 1, wherein the (meth)acrylic ester polymer (A) contains 0.5 mass% or more and 40 mass% or less of the ethylene carbonate-containing monomer as the monomer unit constituting the polymer.

3. The pressure sensitive adhesive composition according to claim 1, wherein the ionic compound (B) is an alkali metal salt.

4. The pressure sensitive adhesive composition according to claim 1, wherein a content of the ionic compound (B) in the pressure sensitive adhesive composition is 0.1 mass parts or more and 2 mass parts or less with respect to 100 mass parts of the (meth)acrylic ester polymer (A).

5. The pressure sensitive adhesive composition according to claim 1, wherein a content of a crosslinker in the pressure sensitive adhesive composition is 0.1 mass parts or less with respect to 100 mass parts of the (meth)acrylic ester polymer (A).

6. A pressure sensitive adhesive obtained by crosslinking the pressure sensitive adhesive composition according to claim 1.

7. A pressure sensitive adhesive sheet comprising at least a pressure sensitive adhesive layer, wherein the pressure sensitive adhesive layer is composed of the pressure sensitive adhesive according to claim 6.

8. A pressure sensitive adhesive sheet comprising at least a pressure sensitive adhesive layer,
wherein a strain amount of a pressure sensitive adhesive constituting the pressure sensitive adhesive layer is 50% or more and 260% or less at 25° C. after 1210 seconds from when applying a stress of 7950 Pa to the pressure sensitive adhesive,
wherein, provided that a maximum relaxation elastic modulus value of the pressure sensitive adhesive constituting the pressure sensitive adhesive layer measured when straining the pressure sensitive adhesive by 10% in accordance with JIS K7244-1 is a maximum relaxation elastic modulus G(t)ₘₐₓ (MPa) and a minimum relaxation elastic modulus value measured while continuing to strain the pressure sensitive adhesive by 10% until 3757 seconds after the maximum relaxation elastic modulus G(t)ₘₐₓ is measured is a minimum relaxation elastic modulus G(t)ₘᵢₙ (MPa), a relaxation elastic modulus fluctuation value Δlog(G(t)) calculated from Formula (X) below is 1.2 or more and 2.0 or less:
$$\text{Δ} log \left(\text{G} \left(\text{t}\right)\right) = log \left(\text{G} {\left(\text{t}\right)}_{max}\right) - log \left(\text{G} {\left(\text{t}\right)}_{\text{min}}\right)$$
.

9. The pressure sensitive adhesive sheet according to claim 7, wherein the pressure sensitive adhesive constituting the pressure sensitive adhesive layer has a gel fraction of 0% or more and 60% or less.

10. The pressure sensitive adhesive sheet according to claim 7, wherein the pressure sensitive adhesive constituting the pressure sensitive adhesive layer has a storage elastic modulus (G′) at 50° C. of 0.01 MPa or more and 1 MPa or less.

11. The pressure sensitive adhesive sheet according to claim 7, wherein the pressure sensitive adhesive constituting the pressure sensitive adhesive layer has a storage elastic modulus (G′) at 25° C. of 0.01 MPa or more and 1 MPa or less.

12. The pressure sensitive adhesive sheet according to claim 7, wherein the pressure sensitive adhesive layer has an adhesive strength to soda-lime glass of 1 N/25 mm or more and 100 N/25 mm or less.

13. The pressure sensitive adhesive sheet according to claim 7, wherein
the pressure sensitive adhesive sheet comprises two release sheets, and
the pressure sensitive adhesive layer is interposed between the two release sheets so as to be in contact with release surfaces of the two release sheets.

14. A laminate comprising:
a display body structural member;
another display body structural member; and
a pressure sensitive adhesive layer that bonds the display body structural member and the other display body structural member to each other,
wherein the pressure sensitive adhesive layer is formed of the pressure sensitive adhesive layer of the pressure sensitive adhesive sheet according to claim 7.

15. The laminate according to claim 14, wherein at least one of the display body structural member and the other display body structural member has a step on a surface on a side bonded by the pressure sensitive adhesive layer.
